(19) United States
(12) Patent Application Publication
(10) Pub. No.: US 2015/0233142 A1
(43) Pub. Date: Aug. 20, 2015

(54) DOOR ACTUATION PART WITH INTEGRATED COUPLING

(71) Applicant: DORMA Deutschland GmbH, Ennepetal (DE)

(72) Inventors: Falko Schweitzer, Schwelm (DE); Leo Lorenz, Wartenberg (DE)

(21) Appl. No.: 14/428,861

(22) PCT Filed: Oct. 17, 2013
(86) PCT No.: PCT/EP2013/071756

§ 371 Date: Mar. 17, 2015

(30) Foreign Application Priority Data
Oct. 17, 2012 (DE) 10 2012 020 450.7
Oct. 17, 2012 (DE) 10 2012 020 451.5

(51) Int. Cl. E05B 1/00; E05B 47/06

(52) U.S. Cl. CPC E05B 1/0007; E05B 47/0642

(57) ABSTRACT

The invention relates to a door actuating member including a housing and a coupling, where the coupling is integrated into the housing.

### TECHNICAL FIELD

The invention relates to a door actuating member comprising a housing and a coupling. Furthermore, the invention relates to a system which comprises at least one inventive door actuating member, one locking cylinder, one connecting element, which is configured in one or more pieces and connects the door actuating member and the locking cylinder, at least one coupling element, which can be connected to a closing cam of the locking cylinder in a torque-proof manner, and which reaches a torque-proof engagement with a coupling disc, and a coupling slider, which can be driven from a non-contacting position into a contacting position with the coupling disc, wherein, when the coupling slider is in the non-contacting position, the door actuating member is freely rotatably without transferring a torque onto the closing cam, and, when the coupling slider is in a contacting position with the coupling disc, a torque, which is applied to the door actuating member, is transferable onto the closing cam via the coupling element.

### BACKGROUND

Door actuating members comprising a housing and a coupling are well known. Likewise, systems comprising door actuating members and locking cylinders are well known. Door actuating members according to the idea of the application are understood to be for example door handles, door knobs or electronical/electromechanical rotating knobs, by means of which, when manually actuated, a door can be unlocked or opened. In particular electronical/electromechanical rotating knobs are utilized to unlock a lock from a door side exclusively after previous authentication, for example by means of a chip or an admission card. Without such authentication, the electronical/electromechanical rotating knob, i.e. the door actuating member according to the idea of the application, is uncoupled from the associated locking cylinder. Therefore, rotating the rotating knob does not result in a rotation of the locking cylinder, in particular not in a following rotation of a closing cam, which rotates along inside the lock.

As, in the uncoupled scenario, the closing cam does not rotate with the rotating knob, the lock is not being unlocked and thus the door cannot be opened. If, however, an authorization for opening the door is provided via an authentication, a coupling slider is brought, by means of a drive element, which may be for example a motor or a mechanical locking cylinder, into positive engagement with a coupling element such that a torque applied to the rotating knob is transferred onto the closing cam of a locking cylinder by means of the coupling slider and the thereto positively connected coupling element.

A door closer system is known from the document DE 102 352 01 B4, in which the rotating knob is coupled to a locking cylinder via a control unit which is located inside a rotating knob. For this purpose, the control unit includes a motor actuator, which is disposed inside the housing, drives the mechanical components of the control unit, and is controlled by means of a control circuit. In this case, the motor actuator drives a toothed control wheel which constitutes a component of a timing gear. The timing gear transforms the rotational movement of the motor actuator into a linear movement of a control slider. In this case, the control slider comprises a control spindle, which has a male thread section, which is in engagement with a female thread in a through borehole of the toothed control wheel. A control cam, which has a control dog and a control surface, is located on the control spindle. In this case, the control cam constitutes the central functional component, which establishes the different functional positions of the closing system in a mechanical manner via a contact with different components of the control unit. It is disadvantageous in this complicated structural embodiment of the mechanical control unit, namely the transformation of the rotational movement of the motor actuator into a linear movement of the control slider via a timing gear, that this embodiment of an actuator drive requires a comparably high amount of energy. In addition, the control slider, by means of which, in the coupling scenario, the torque applied to the door actuating member is to be transferred onto the closing cam, is located outside the housing of the door actuating member. In this case, the control cam is displaced along the axis of rotation towards the locking cylinder and enters an axial recess of the locking cylinder, respectively an intermediate member, which couples the locking cylinder to the door actuating member. This spatial separation of the control cam from the motor actuator outside the rotating knob requires connecting elements, which, on the one hand, overcome the spatial distance between the motor disposed in the rotating knob and the control cam, and by means of which the rotational movement of the motor is transformed into a linear movement, such that the known door closing systems cannot be executed to be energy efficient.

### BRIEF SUMMARY

The invention is to modify the structural complicated type of construction of a door actuating member known from the state-of-the-art and to implement it as a door actuating member designed to have only a few structural members. In addition, it is the object of the present invention to increase the capacity of a door actuating member in that the latter is configured with simple structural measures and becomes thereby energy efficient.

The invention includes the technical teaching that the coupling is integrated in the housing. According to the idea of the application, “integrated” is to be understood in that the coupling with all its essential components is accommodated to be fully integrated in the housing of the door actuating member.

This solution offers the advantage of the inventive door actuating member being connectable to any locking cylinder without requiring a specific locking cylinder in which relevant elements are disposed for the coupling. In addition, the inventive door actuating member, on account of the integration of the coupling into the housing, offers the advantage of being able to forego a transmission, which transforms a rotational movement of a drive element into a linear movement of a coupling element outside the door actuating member. This reduces considerably the energy consumption of the inventive door actuating member.

In an advantageous manner, the coupling, which is integrated into the inside of the housing of the door actuating member, comprises a coupling slider, a coupling disc, and at least one drive element via which the coupling slider is drivable. In this case, in the coupling position, the coupling slider preferably reaches a positive-locking fit with the coupling disc.

In a preferred manner, the coupling slider is directly linearly driven by the drive element. For driving the coupling slider inside the housing of the door actuating member, a motor, in the shape of a traction actuator motor, is particularly suitable, via which a spindle is linearly driven. Preferably in this case, the coupling slider is located on the free end of the spindle such that the former is directly driven by the motor, respectively by the drive element without a transformation via a transmission. Obviously, the drive element may be likewise a commercially available locking cylinder which is actuated by a key or otherwise, or a switch, which both are in contact with the coupling slider and linearly move the latter into contact and out of contact with the coupling disc.

On account of the movement, effected by the drive element, of the coupling slider in the direction of the coupling disc, which is a component of the integrated coupling, the coupling slider reaches a contacting position with the coupling disc. In order to reach a positive-locking fit of the coupling disc and the coupling slider, the coupling disc, on its exterior circumference, has preferably recesses and/or dogs, into which, respectively towards which the coupling slider moves to reach the positive-locking fit with its end facing away from the drive element, preferably with a thereto conformed engagement element, for example in the shape of a dog or of a cylinder. In the event of the positive-locking fit of the coupling slider with the coupling element, i.e. in contacting position with the coupling disc, the housing is non-positively and/or positively connected to the closing cam via a coupling element configured as a coupling shaft. In this position, namely in the contacting position or also referred to as coupling position, a torque applied to the door actuating member, respectively a torque applied to the housing of the door actuating member, wherein the housing reaches engagement with the coupling slider, is transferred onto the locking cylinder and in this case particularly onto the closing cam via the coupling element. In the present case, the feature of a coupling element is in particular to be understood as a coupling disc, which, together with the coupling slider, constitutes the coupling integrated into the housing.

According to the invention, driving the coupling slider into the contacting position, respectively non-contacting position with the coupling disc, by means of which the closing cam is ultimately supported to be torque-proof, is realized within the housing of the door actuating member.

Preferably, a sensor serves for monitoring the position of the coupling, more precisely for monitoring the position of the coupling slider. Preferably, the sensor is able to detect the coupling conditions: uncoupled, i.e. the coupling slider is in a non-contacting position with the coupling element, coupled, i.e. the coupling slider is in a contacting position with the coupling element, and an intermediate position between the non-contacting position and the contacting position of the coupling slider with the coupling element.

In a preferred manner, an optoelectronic sensor in the shape of at least one light barrier is suitable as the sensor, which detects the position, i.e. the coupling condition of the coupling slider. Preferably in this case, the light barrier comprises an infrared LED (IR LED) and a phototransistor, which is placed at a distance opposite the IR LED. In this case, a printed circuit board, which is preferably supported inside the housing in front of the coupling disc, is directly equipped with the components of the light barrier, namely the IR LED and the phototransistor. So that the coupling slider can be linearly moved by the drive element through the printed circuit board, preferably, the printed circuit board has an aperture, which allows for a linear movement of the coupling slider. Preferably, the printed circuit board is equipped on both sides, i.e. both surfaces of the printed circuit board are equipped with one respective light barrier. In this case, the printed circuit board advantageously serves as a shading device for preventing a cross-reaction, i.e. a projection of infrared beams of the one light barrier onto the phototransistor of the other light barrier. For passing through the light beam of the light barriers and for being able to detect thereby the position of the coupling slider, the coupling slider has a leaflet, which, during the linear movement of the coupling slider, is guided through the light barriers.

Mechanical rotating knobs, electronical/electromechanical rotating knobs and door handles are to be understood as door actuating members with a fully integrated coupling according to the idea of the invention.

The inventive system includes the technical teaching that the coupling disc and the coupling slider are integrated into the door actuating member.

With the intention to avoid repeating the advantages of the inventive system, which result from the integration of the coupling slider and the coupling disc, i.e. the integration of the coupling into the door actuating member, it is referred to the explanations on the inventive door actuating member.

In a preferred manner, a connecting element is utilized in the system, which connects the door actuating member and the locking cylinder via a variable distance to each other, wherein the distance between the door actuating member and the locking cylinder is adjustable via the connecting element. With the intention to maintain the mode of operation of the door actuating member in the system with respect to the given variability, the torque transfer from the door actuating member onto the locking cylinder must be adjustable via a variable distance, which distance is created by the connecting element. In order to guarantee said variable, respectively adjustable distance, the coupling disc has a conformed tenon, which reaches through a borehole of the connecting element. The tenon itself has a borehole as well, in which a coupling element in the shape of a coupling shaft, which is connected to the closing cam, is brought into a torque-proof engagement. As both the coupling shaft and the tenon are adapted to the length of the connecting element, and the coupling shaft is engaged in a torque-proof manner in the borehole of the tenon of the coupling disc and of the connecting element, the torque transfer from the door actuating member onto the locking cylinder via the coupling element is variably adaptable according to the distance of the door actuating member to the locking cylinder.

For reducing the number of components of the system, the end of the connecting element facing the door actuating member, is preferably configured as the bottom for the housing of the door actuating member. In order to protect the housing against unintentional, respectively intentional removal from the connecting element, the housing projects beyond the circumference of the bottom and is preferably crimped over the bottom.

Within the housing and at the bottom, which is formed by means of the connecting element, the coupling element, in this case in particular the coupling disc, reaches abutment. For preventing a collision of the coupling slider, in the present case in particular of the engagement element with for example one of the dogs configured in the circumference of the coupling disc, permanent magnets are disposed at the bottom, which are homopolar with regard to the permanent magnets disposed at the coupling disc. The repelling force of the homopolar permanent magnets results in the fact that the dogs, which are configured in the circumference of the coupling disc, are out of a collision position with regard to the coupling slider.

### BRIEF DESCRIPTION OF THE DRAWINGS

Further advantages of the system will be described based on the description of the FIG. 3 and can be deducted from the description of the door actuating member in FIGS. 1 and 2.

Altogether, further measures enhancing the invention will be illustrated in the following in detail in conjunction with the description of one preferred embodiment of the invention based on the Figures, in which:

FIG. 1 shows, in a perspective partial view, an inventive door actuating member, which comprises a housing and a coupling integrated into the housing,

FIG. 2 shows the door actuating member with the therein integrated coupling of FIG. 1, which member is connected to a connecting element, in a perspective view onto the light barriers disposed at the printed circuit board within the housing, and

FIG. 3 shows an exploded view of an inventive system, which comprises two door actuating members, a locking cylinder, and the connecting elements connecting the door actuating members to the locking cylinder.

Throughout the different Figures, same parts are always identified by the same reference numerals, and therefore they will be normally only described once.

### DETAILED DESCRIPTION

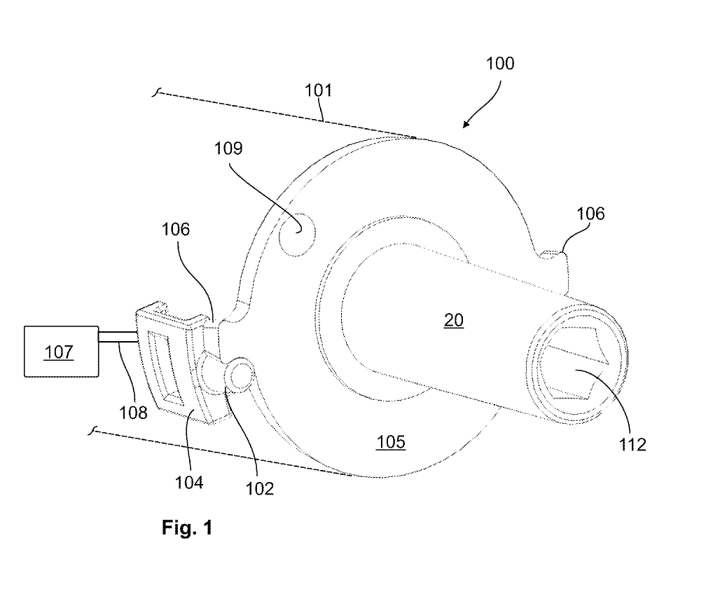

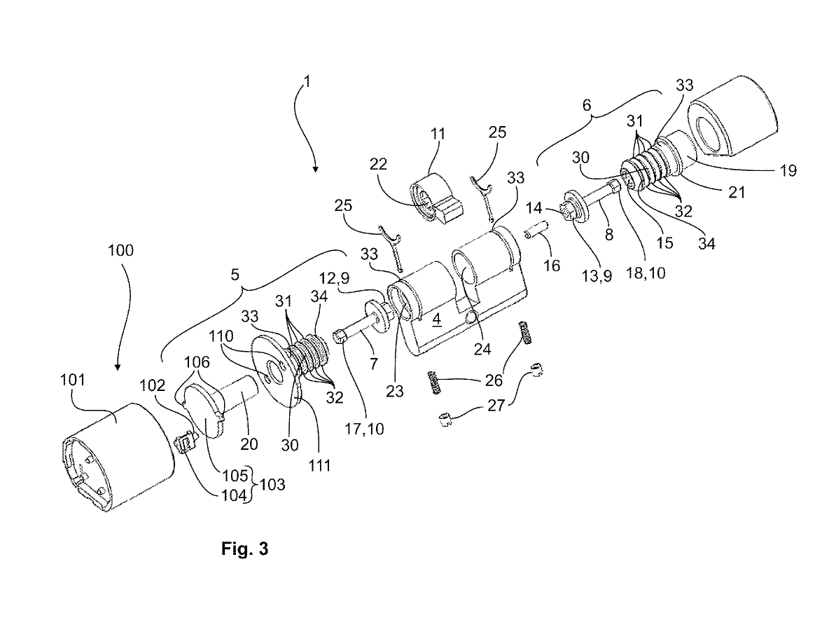

FIG. 1 shows an exemplary embodiment of an inventive door actuating member 100. The door actuating member 100 comprises a housing 101, which in the present FIG. 1, is illustrated as a dashed line, and a coupling 103, which comprises a coupling disc 105 and a coupling slider 104. As illustrated in the Figure, the coupling disc 105 and the coupling slider 104 are integral components of the housing 101 of the door actuating member 100. In other words, the coupling disc 105 and the coupling slider 104, namely the coupling 103, are fully accommodated with their circumference in the housing 101 of the door actuating member 100. The coupling slider 104 is driven by a drive element 107. For this purpose, the coupling slider 104 is disposed on a spindle 108, which is connected to the drive element 107. As illustrated in FIG. 1, within the housing 101 and via an engagement element 102, the coupling slider 104 is non-positively and/or positively connected to dogs 106, which are configured at the coupling disc 105. In this position, the coupling slider 104 is driven into the contacting position with the coupling disc 105 by means of the drive element 107 via the spindle 108. In this contacting position, a torque applied to the housing 101 of the door actuating member 100 is transferable onto a coupling element 7 via the coupling slider 104, which reaches an engagement with the housing 101, via the engagement element 102 which is non-positively and/or positively connected to the dogs 106 of the coupling disc 105, via the coupling disc 105, and via a tenon 20 configured at the coupling disc 105. In this case, the coupling element 7, with its end 17 configured as a hexagon, respectively a hexagon nut 10 screwed onto it, engages in a borehole 112, which is configured at the tenon 20 of the coupling disc 105. The tenon 20, as better shown in the following FIG. 3, is guided through the borehole of a connecting element 5, whereby the coupling disc 105 reaches an abutment at a bottom 111 of the housing 101, which bottom is configured by the connecting element 30.

For avoiding a collision position of the engagement element 102 of the coupling slider 104 with the dogs 106 of the coupling disc 105, permanent magnets 109 are disposed at the coupling disc 105, at the surface of the coupling disc 105 facing the tenon 20. Permanent magnets 110, having the same polarity as the permanent magnets 109 of the coupling disc 105, are disposed at the bottom 111 of the connecting element 30. On account of the position of the permanent magnets 109 and 110 with regard to each other, the coupling disc 105 can be aligned with regard to the bottom 111 of the connecting element 30 in such a way that a collision of the coupling slider 104, in particular of the engagement element 102 with the dogs 106 of the coupling disc 105 is prevented, such that the engagement element 102 reaches an engagement at the dogs 106 at the circumference of the coupling disc 105.

The drive element 107, which is just diagrammatically illustrated in the Figure, may be a motor, for example a DC-motor, a pressure controller, a switch, but also a locking cylinder, which all realize a linear movement of the coupling slider 104 via the spindle 108. Obviously, the spindle 108 may be likewise configured by means of the another connecting element connecting the drive element 107 to the coupling slider 104.

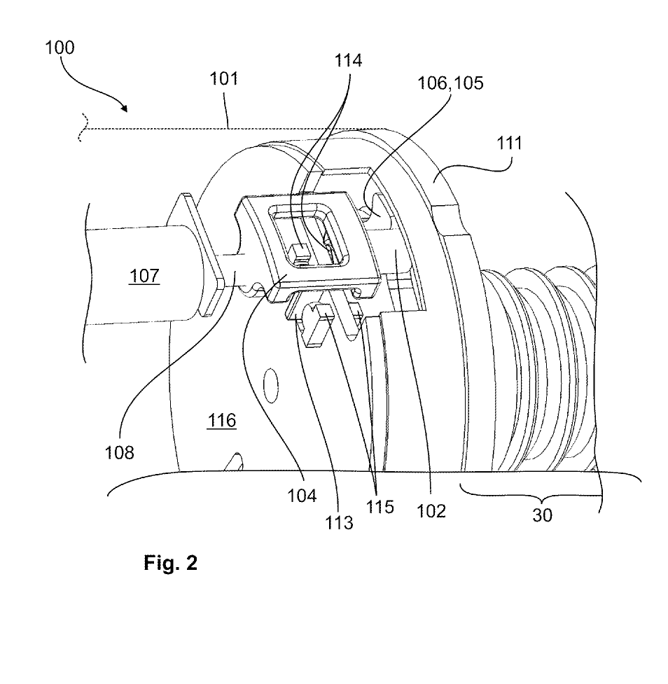

FIG. 2 shows the door actuating member 100 of FIG. 1 in a perspective lateral view, wherein a view through a window configured in the coupling slider 104 reveals a sensor, in the present case two light barriers, which are spaced apart parallel to each other and respectively consist of an IR LED 114 and a phototransistor 115. In this case, a two-sided printed circuit board 116 is equipped with the two light barriers in such a way that the printed circuit board 116 configured between the light barrier serves as a shading element between the light barriers. This prevents that the light emitted by the IR LED 114 of the one light barrier from being incident on the phototransistor 115 of the other light barrier disposed on the other side of the printed circuit board 116. A leaflet 113 is configured at the coupling slider 104, below the coupling slider 104, which leaflet slides through the light barriers with the linear displacement of the coupling slider 104, a displacement driven by the drive element 107 via the spindle 108, and thereby interrupts the light beams directed from the IR LEDs 114 onto the phototransistors 115, wherein the interruption of the light beams is utilized as a signal for the position detection of the coupling slider 104.

FIG. 3 shows an exploded view of an exemplary embodiment of an inventive system 1, comprising an exemplary embodiment of an inventive door actuating member 100 and a door actuating member 3 configured as a rotating knob, a locking cylinder 4, and the connecting elements 5 and 6 connecting the door actuating members 100 and 3 and locking cylinder 4, which elements in the present case are configured in multiple pieces and connect the door actuating members 100 and 3 and the locking cylinder 4 via a variable distance to each other, wherein the distance between the door actuating members 100 and 3 and the locking cylinder 4 is adjustable via the connecting elements 5 and 6.

The connecting elements 5 and 6 comprise latching shafts 30 through which, with regard to the connecting element 5, a coupling element 7 passes and transfers the torque from the door actuating member 100 onto the locking cylinder 4, respectively with regard to the connecting element 6, a coupling element 8 engages and transfers the torque from the door actuating member 3 onto the locking cylinder 4. In this case, the coupling elements 7 and 8 are preferably configured as a shaft.

In order to be able to accommodate the latching shafts 30 of the connecting elements 5 and 6, the locking cylinder 4 has receptions 23 and 24 which, in a usual manner, serve for receiving a cylinder core. For supporting the latching shafts 30 in the receptions 23 and 24, at their ends 34 facing away from the door actuating members 100 and 3, the latching shafts 30 have respectively one bearing surface 34. In this case, the bearing surface 34 has a slightly larger diameter than the diameter of the rings 31, respectively of the shaft ridges of the latching shaft 30. Thereby, not only a support of the latching shaft 30 in the locking cylinder 4 is guaranteed, but the slightly larger diameter of the bearing surface with regard to the rings 31 of the latching shaft 30 also increases the movability of the latching shaft 30 in the reception 23 or 24 outside its axial extension. In other words, the degrees of freedom of an alignment to a locking cylinder 4 aligned in a lock by means of the above described embodiment of the latching shaft 30 are even increased. On the ends facing the door actuating members 100 and 3 respectively one bearing surface 33 is likewise configured at the latching shafts 30, which have a slightly larger diameter than the diameter of the rings 31, respectively of the shaft ridges of the latching shaft 30. Preferably, the bearing surfaces 33 are supported in compensating elements in the shape of a clip, respectively of a rosette bearing, which, in the present case, are not illustrated. In this regard, the latching shafts are supported at two locations, namely via the bearing surfaces 33 and 34, namely on the one hand, in the receptions 23 and 24 of the locking cylinder 4, and on the other hand, in the rosette bearings, which in the present case are not illustrated, in the area of the door actuating members 100 and 3.

At their respective ends 12 and 13 facing away from the door actuating members 100 and 3, the coupling elements 7 and 8 have an exterior contour in the shape of a hexagon nut 9, wherein the hexagon nut 9 reaches a torque-proof engagement with a closing cam 11 of the locking cylinder 4.

For this purpose, the closing cam 11 includes in this case an exemplary continuous borehole 22 in the shape of a hexagon bore, by means of which it reaches an engagement with the ends 12 and 13 of the coupling elements 7 and 8. In this case, the coupling element 7 itself may be embodied as a hexagon, which reaches a torque-proof engagement with the borehole 22 of the closing cam 11.

In the present case, the coupling elements 7 and 8, at their ends 12 and 13 facing away from the door actuating members 100 and 3, additionally include one respective borehole 14, into which, while bringing the respective ends 12 and 13 into engagement with the closing cam 11, a draw bolt 16 is inserted, which has the purpose of connecting the ends 12 and 13, in particular of clamping the ends 12 and 13.

At the respective ends 17 and 18 facing the door actuating members 100 and 3, the coupling elements 7 and 8 likewise have an exterior contour in the shape of a hexagon nut 10, which reaches a torque-proof engagement in a borehole 15 of the latching shaft 30 of the connecting element 6. In this case, the borehole 15 is configured as a hexagon bore for enabling a torque-proof accommodation of the hexagon nut 10. Obviously, the coupling element 7 itself may be configured as a hexagon as well, which reaches a torque-proof engagement with the borehole 15 of the latching shaft 30 of the connecting element 6. In the present case, the hexagon nuts 9 and 10 at the ends 12, 13, 17 and 18 of the coupling elements 7 and 8 are configured in different sizes, which facilitate orienting the coupling elements 7 and 8 during installation of the system 1. Obviously, the exterior contour of the ends 12, 13, 17 and 18 of the coupling elements 7 and 8 may have a different contour than the one of a hexagon nut 9 and 10, such as for example the shape of a Torx or of an internal hexagon. Obviously, in this case the boreholes as well, which serve for accommodating the coupling elements 7 and 8, will have to be adapted to the shape of the ends 12, 13, 17, and 18. Moreover, it is however not necessarily required to adapt for example the borehole 15 of the exterior contour to the end 18 of the coupling element 8, to have the coupling element 8 reach a torque-proof engagement with the borehole 15. The borehole 15 could be for example likewise configured as a blind hole, into which the coupling element 8 is pressed with its end 18. Obviously, it is likewise conceivable to provide different boreholes, respectively different exterior contours of the ends 12, 13, 17, and 18 in combination with each other. Thus, the borehole 15 for example at a door actuating member 100 or 3 could be configured as a blind hole, and a borehole corresponding to the borehole 15 at the other door actuating member 100 or 3 could be configured as a hexagon bore. This embodiment could for example serve for a better orientation during installation of the system.

In the present specific embodiment of the inventive system 1, in addition to the latching shaft 30 and the coupling element 7, the connecting element 5 comprises at the side facing the left door actuating member 100, a coupling disc 105, which engages with a tenon 20 in the latching shaft 30 of the connecting element 5.

The tenon 20 has a corresponding recess, respectively borehole pointing at least in the direction of the coupling element 7, by means of which it reaches a torque-proof engagement with the end 17 of the coupling element 7. In FIG. 3, the borehole is concealed and therefore not visible. Therefore, in the present specific embodiment, the latching shaft 30 of the connecting element 5 is supported to be freely rotatable on the coupling element 7 and is in particular supported to be freely rotatable on the tenon 20 of the coupling disc 105, wherein the tenon 20 reaches a torque-proof engagement with the coupling element 7.

Via the housing 101, the door actuating member 100 can be fitted onto the connecting element 5 in a torque-proof manner via the portion of the latching shaft 30 forming the bottom 111 of the housing 101, wherein the coupling disc 105 is integrated, i.e. accommodated in the housing 101 of the door actuating member 100, such that, in the uncoupled condition, no torque is transferred from the door actuating member 100 onto the locking cylinder 4 via the coupling element 7. The torque-proof connection between the latching shaft 30 and the housing 101 may be realized for example by means of riveting, gluing, welding the housing 101 to the bottom 111. Preferably, the connection may be likewise realized by crimping the housing 101 over the bottom 111. In this case again, it is likewise conceivable to press the bottom 111 into the housing 101 or to otherwise connect it non-positively, positively by material and/or positively to the housing 101.

As, in the uncoupled scenario, the closing cam 11 does not rotate with the door actuating member 100, the lock is not unlocked and thus the door cannot be opened. It is only an authentication, for example by means of a chip, a code or a card that results in coupling the door actuating member 100 to the coupling disc 105 such that the torque applied to the door actuating member 100 via the coupling disc 105, and in particular via the tenon 20 configured at the coupling disc 105 is transferred onto the coupling element 7 and thereby onto the closing cam 11.

In contrast thereto, at the end of the latching shaft 30 of the connecting element 6 facing the door actuating member 3, the door actuating member 3 is supported at a reception 19 in a torque-proof manner, such that, when actuating the door actuating member 3, the applied torque is transferred onto the locking cylinder 4 via the latching shaft 30 and the coupling element 8. As a depth abutment for the door actuating member 3, a circumferential collar 21 is configured at the end of the latching shaft 30 of the connecting element 6 at the reception 19.

With the intention to guarantee that, once the system 1 is installed, the connecting elements 5 and 6 can not be removed from the receptions 23 and 24 of the locking cylinder 4, securing elements 25 are provided at each reception 23 and 24 of the locking cylinder 4.

The securing elements 25 are retained below the receptions 23 and 24 in a non-illustrated borehole in the locking cylinder 4 at a pin-shaped portion forming the lower part of the securing elements 25 and are guided in slots 33 in the locking cylinder 4 in the area of the receptions 23 and 24. Preferably, in this case a compression spring 26 is pushed onto the pin-shaped portions of the securing elements 25, such that the securing elements 25 are spring-loaded upwards, i.e. in the direction of the receptions 23 and 24. If, contrary to the illustration, the latching shaft of the connecting elements 5 and 6 would be able to be accommodated in receptions of the door actuating members 100 and 3, it would be conceivable to configure the securing elements 25 at the door actuating members 100 and 3. In this case, the securing elements 25 could be likewise configured as screws or as insertable pins. In the present case however, preferably spring-loaded securing elements 25 are suitable, because the locking cylinder 4 is usually installed in the lock of a door, and a manual securing by means of securing elements 25, which are configured as a screw or as an insertable pin, is not possible during installation.

The top part of the securing elements 25 is formed by means of a crescent-shaped portion. In this case, the crescent shaped portion is adapted to the size of the latching shaft 30 of the connecting element 5 and 6, in particular to the shaft troughs thereof, which are configured as an annular groove 31 located on the outside. Upon inserting the latching shaft 30 of the connecting element 5 or 6, due to the spring-load, which is transferred from the compression spring 26 via the lower pin-shaped part of the securing element 25 onto the crescent-shaped portion of the securing element 25, the securing element 25 with its crescent-shaped portion automatically engages in an annular groove 31 of the latching shaft 30 of the connecting element 5 or 6 and, when pushing forward the latching shaft 30 of the connecting element 5 or 6 further towards the closing cam 11, slides again out of the annular groove 31 and slips beyond the ring 32 of the latching shaft 30 of the connecting element 5 or 6, the ring 32 following the annular groove 31. Thereupon, corresponding to the advance of the latching shaft 30 of the connecting element 5 or 6, the securing element 25 engages in the following annular groove 31. In order to comply with the requirements as to variability of the inventive system during installation, it is therefore advantageous to equip the latching shaft 30 of the connecting element 5 or 6 with a corresponding high number of rings 32 and annular grooves 31 in a tight succession, i.e. with a small distance to each other, in order to be able to adjust a variable distance between the door actuating members 100 and 3 and the locking cylinder 4. In case the succession of the annular grooves 31 and of the rings 32, i.e. the configuration of the latching shaft 30 of the connecting element 5 or 6 would result in the securing element 25 just not exactly engaging in an annular groove 31, but bearing instead against a ring 32, in an advantageous manner it is intended to install spacers in the inventive system, such that the securing element 25 moves from the ring 32 of the latching shaft 30 of the connecting element 5 or 6 and engages in an annular groove 31 preceding the ring 32.

For securing the compression spring 26 and the securing element 25 in the borehole of the locking cylinder 4, in the lower part of the borehole, a threaded bushing 27 can be screwed to a threaded portion, wherein the threaded portion may be configured either at the lower part of the securing element 25 or in the walling of the borehole. On account of the pre-tension of the compression spring 26, which is adjustable via the threaded bushing 27, the securing element 25 with its upper part, which in the present case is configured as a crescent-shaped portion, presses against the latching shaft 30 of the connecting element 5 or 6, whereby the securing element 25 with its upper part automatically engages in an annular groove 31 of the latching shaft 30 of the connecting element 5 or 6.

Instead of a multipart securing element 25, which, in the presently intended mode of operation, comprises a compression spring 26 and a threaded bushing 27, a securing element 25 with a conformed and embossed leaf spring for securing the latching shaft 30 could be retained in the reception 23 and/or 24 in a non-illustrated borehole in the locking cylinder 4 and guided in slots 33 in the locking cylinder 4 in the area of the receptions 23 and 24.

Instead of the door actuating members 100 and 3 illustrated in FIG. 3, which are configured as rotating knobs, wherein the door actuating member 100 is a special electronical/electromechanical rotating knob, according to the idea of the invention, the door actuating members 100 and 3 could be configured as well on both sides for example as simple rotating knobs or door handles. Obviously, likewise combinations of door handles with rotating knobs or with electronical/electromechanical rotating knobs are conceivable. Likewise door knobs, fixed on one side, can be combined according to the idea of the invention with rotating knobs, electronical/electromechanical rotating knobs and door handles. It is also conceivable to install the inventive system in a knob cylinder, which, on one side, is actuated by a key and, on the other side, by a fixed and installed rotatable knob. Altogether, the inventive system can be utilized for different construction forms, such as profile cylinders, round cylinders, oval cylinders, which are configured as half cylinders or as double cylinders.

In addition, the system as well as the door actuating member should not be understood for the exclusive installation in doors. It is rather conceivable to utilize the system for installation in window actuating members as well, respectively to utilize the inventive door actuating member as a window actuating member.

The invention in its configuration is not limited to the above presented preferred embodiment of a door actuating member, respectively of a system. On the contrary, a number of variants are conceivable, which make use of the illustrated solution, even with basically different types of embodiments. All features and/or advantages including the constructional details, spatial dispositions and method steps, resulting from the claims, the description or the drawings, may be essential to the invention, both by themselves and in the most various combinations.

1. A door actuating member, comprising a housing and a coupling, wherein the coupling is integrated into the housing.

2. The door actuating member according to claim 1, wherein the coupling comprises a coupling slider, a coupling disc and at least one drive element, by means of which the coupling slider can be driven.

3. The door actuating member according to claim 2, wherein the coupling disc comprises at least one dog, aperture or recess, which reaches engagement with an engagement element 102 of the coupling slider.

4. The door actuating member according to claim 1, wherein the drive element drives the coupling slider from a non-contacting position into a contacting position with the coupling disc.

5. The door actuating member according to claim 4, wherein the drive element drives the coupling slider from the contacting position into the non-contacting position with the coupling disc.

6. The door actuating member according to claim 4, wherein, in the contacting position, the coupling slider non-positively and/or positively connects the housing to the coupling disc.

7. The door actuating member according to claim 4, wherein, in the contacting position, the coupling slider transfers a torque applied to the housing onto the coupling disc.

8. The door actuating member according to claim 1, wherein the drive element directly drives the coupling slider.

9. The door actuating member according to claim 1, wherein the drive element is a motor, a locking cylinder or a switch.

10. The door actuating member according to claim 1, wherein a sensor detects the position of the coupling slider, in particular the contacting position, the non-contacting position and an intermediate position.

11. The door actuating member according to claim 10, wherein the sensor optoelectronically detects the position of the coupling slider.

12. The door actuating member according to claim 1, which is configured as a door handle, a door knob, a mechanical rotating knob or as an electronical/electromechanical rotating knob.

13. A system, comprising at least one door actuating member, in particular according to preceding claim 1, a locking cylinder, a connecting element, which is configured in one or more pieces and connects the door actuating member and the locking cylinder, at least one coupling element, which can be connected to a closing cam of the locking cylinder in a torque-proof manner and reaches a torque-proof engagement with a coupling disc, and a coupling slider, which can be driven from a non-contacting position into a contacting position with the coupling disc, wherein, when the coupling slider is in the non-contacting position, the door actuating member is freely rotatable without transferring a torque onto the closing cam, and wherein, when the coupling slider is in the contacting position with the coupling disc, the coupling element is able to transfer a torque applied to the door actuating member onto the closing cam, wherein the coupling disc and the coupling slider are integrated into the door actuating member.

14. The system according to claim 13, wherein the connecting element connects the door actuating member and the locking cylinder to each other via a variable distance, wherein the distance between the door actuating member and the locking cylinder is adjustable via the connecting element.

15. The system according to claim 13, wherein the connecting element includes a borehole through which the coupling element is guided and reaches a torque-proof engagement with the coupling disc.

16. The system according to claim 13, wherein the end of the connecting element facing the door actuating member is configured as a bottom for the housing of the door actuating member.

17. The system according to claim 16, wherein the housing surrounds the bottom at least partially.
